(19) United States
(12) Patent Application Publication
(10) Pub. No.: US 2020/0082081 A1
(43) Pub. Date: Mar. 12, 2020

(54) SYSTEMS AND METHODS FOR THREAT AND INFORMATION PROTECTION THROUGH FILE CLASSIFICATION

(71) Applicant: Symantec Corporation, Mountain View, CA (US)

(72) Inventors: Sumit Sarin, Pune (IN); Shireen Rivera, Los Angeles, CA (US); Nicolas Popp, Los Altos Hills, CA (US); Milind Torney, Dublin, CA (US)

(21) Appl. No.: 16/128,993

(22) Filed: Sep. 12, 2018

(51) Int. Cl. G06F 21/56; G06F 21/55; G06F 21/57; G06F 21/53; H04L 29/06; G06F 17/30

(52) U.S. Cl. CPC G06F 21/566; G06F 21/554; G06F 21/565; G06F 2221/034; G06F 21/53; H04L 63/20; G06F 17/30144; G06F 21/577

(57) ABSTRACT

The disclosed computer-implemented method for threat and information protection through file classification may include (1) assigning a classification tag to each of an number of files on a computing device based on a set of rules, (2) storing the classification tag in the files and a corresponding file descriptor describing a sensitivity level of the files externally to the files, (3) detecting creation of a process associated with accessing the files, (4) determining whether the process is potentially suspicious, (5) identifying an operation initiated by the potentially suspicious process to access the files, and (6) performing a security action that protects the computing device from malicious activity by the operation initiated by the potentially suspicious process. Various other methods, systems, and computer-readable media are also disclosed.

### BACKGROUND

Enterprises and other organizations may typically store sensitive information as files on one or more computing systems for access by authorized users. Due to the ever-growing sophistication of malware attacks, the sensitive information in these files is increasingly at risk of exfiltration by seemingly benign processes which may in fact be malicious and consequently cause the sensitive information to be removed from the affected computing systems. Moreover, these malicious processes may further encrypt or obfuscate the sensitive information being removed, thereby making detection difficult.

Traditional security systems designed to protect computing systems from malware attacks may utilize various methods such as reputation and runtime behavior to identify malicious processes but may have no means of detecting and removing malicious processes that exfiltrate data without causing further damage to the affected computing systems. In particular, traditional security systems designed to utilize reputation and runtime behavior to detect viruses, Trojans, keyloggers, and other threats, may not be able to detect processes designed to search computing systems for sensitive files and later encrypt or obfuscate the files during exfiltration.

### SUMMARY

As will be described in greater detail below, the instant disclosure describes various systems and methods for threat and information protection through file classification.

In one example, a method for threat and information protection through file classification may include (1) assigning a classification tag to each of one or more files on the computing device based on a set of rules, (2) storing the classification tag in the files and a corresponding file descriptor describing a sensitivity level of the files, based on the rules, externally to the files, (3) detecting creation of a process associated with accessing the files, (4) determining whether the process is potentially suspicious, (5) identifying, upon determining that the process is potentially suspicious, an operation initiated by the potentially suspicious process to access the files, and (6) performing, based on the sensitivity level of the files, a security action that protects the computing device from malicious activity by the operation initiated by the potentially suspicious process.

In some embodiments, the security action may include retrieving the file descriptor stored externally to the files from a data storage without reading any content contained in the files. Additionally or alternatively, the security action may include blocking the operation initiated by the potentially suspicious process and then sandboxing the potentially suspicious process when the sensitivity level of the files is below a sensitivity threshold. Additionally or alternatively, the security action may include, after blocking the operation initiated by the potentially suspicious process, terminating the potentially suspicious process when the sensitivity of the files meets or exceeds the sensitivity threshold. Additionally or alternatively, the security action may include, after blocking the operation initiated by the potentially suspicious process, quarantining the potentially suspicious process when the sensitivity of the files meets or exceeds the sensitivity threshold. Additionally or alternatively, the security action may include, after blocking the operation initiated by the potentially suspicious process, deleting the potentially suspicious process and its associated binaries and content files when the sensitivity of the files meets or exceeds the sensitivity threshold.

In some examples, the security action may further include performing, based on a security value associated with the computing device, additional security actions. The additional security actions may include (1) initiating a security scan on the computing device and (2) preventing the computing device from connecting to a non-secure network.

In one example, determining whether the process is potentially suspicious may include determining that the process is not suspicious. In this example, when the process is determined to not be suspicious, an additional security action may be still be performed to sandbox the process when the sensitivity level of the files meets or exceeds the sensitivity threshold.

In some embodiments, storing the classification tag and the corresponding file descriptor may include updating a count corresponding to a number of sensitive files on the computing device. In some examples, the rules may include content and/or context rules.

In one embodiment, a system for threat and information protection through file classification may include at least one physical processor and physical memory that includes a set of modules and computer-executable instructions that, when executed by the physical processor, cause the physical processor to (1) assign, by a tagging module, a classification tag to each of one or more files on a computing device based on a set of rules, (2) store, by a storage module, the classification tag in the files and a corresponding file descriptor describing a sensitivity level of the files, based on the rules, externally to the files, (3) detect, by a detection module, creation of a process associated with accessing the files, (4) determine, by a determining module, whether the process is potentially suspicious, (5) identify, by an identification module, upon determining that the process is potentially suspicious, an operation initiated by the potentially suspicious process to access the files, and (6) perform, by a security module, based on the sensitivity level of the files, a security action that protects the computing device from malicious activity by the operation initiated by the potentially suspicious process.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) assign a classification tag to each of one or more files on the computing device with a based on a set of rules, (2) store the classification tag in the files and a corresponding file descriptor describing a sensitivity level of the files, based on the rules, externally to the files, (3) detect creation of a process associated with accessing the files, (4) determine whether the process is potentially suspicious, (5) identify, upon determining that the process is potentially suspicious, an operation initiated by the potentially suspicious process to access the files, and (6) perform, based on the sensitivity level of the files, a security action that protects the computing device from malicious activity by the operation initiated by the potentially suspicious process.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for threat and information protection through file classification.

FIG. 2 is a block diagram of an additional example system for threat and information protection through file classification.

FIG. 3 is a flow diagram of an example method for threat and information protection through file classification.

FIG. 4 is a block diagram of an additional example system for threat and information protection through file classification.

FIG. 5 is a block diagram of an example computing system capable of implementing one or more of the embodiments described and/or illustrated herein.

FIG. 6 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for threat and information protection through file classification. As will be explained in greater detail below, by tagging/classifying files to identify a sensitivity level of files stored on a computing device, the systems and methods described herein may detect and remediate potentially suspicious processes designed to exfiltrate sensitive file information that may otherwise be missed using traditional security solutions and thereby prevent data loss.

In addition, the systems and methods described herein may improve the functioning of a computing device and/or the technical field of computer security by reducing the computing device's susceptibility to malicious processes designed to exfiltrate sensitive information from data files. Detecting these processes before they are able to access the data files and, additionally, performing actions to remediate these processes on the computing device, may prevent these processes from exfiltrating sensitive information and subsequent data loss from important files.

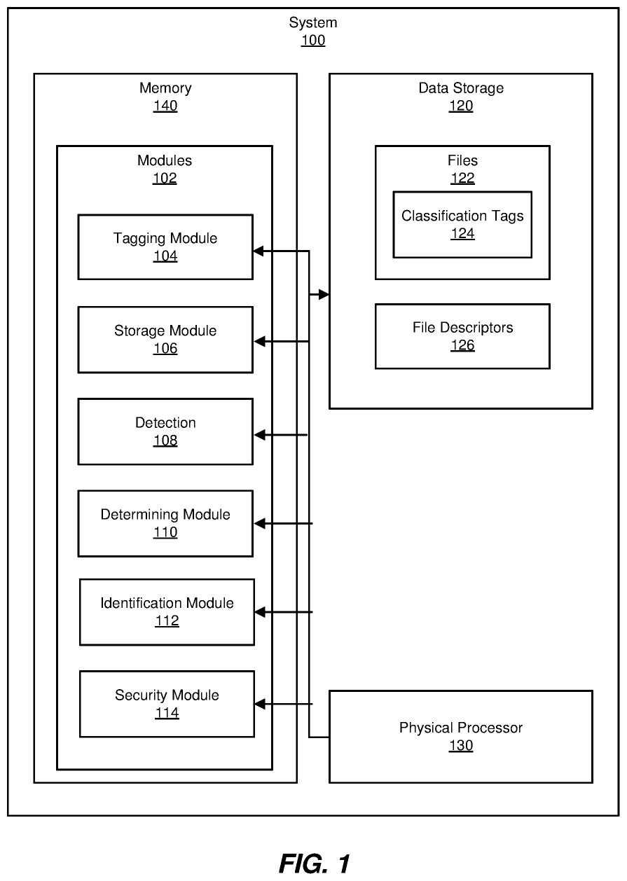

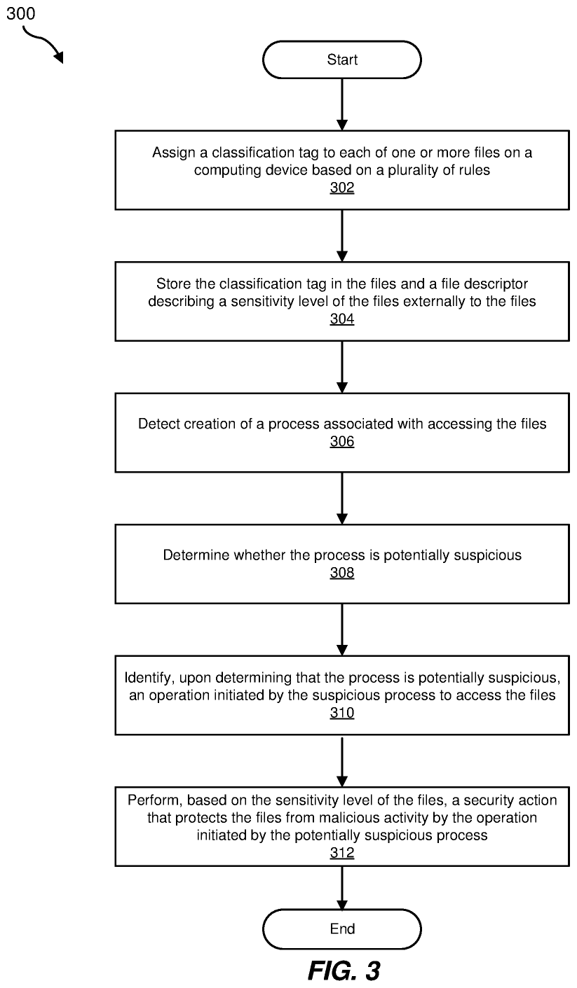

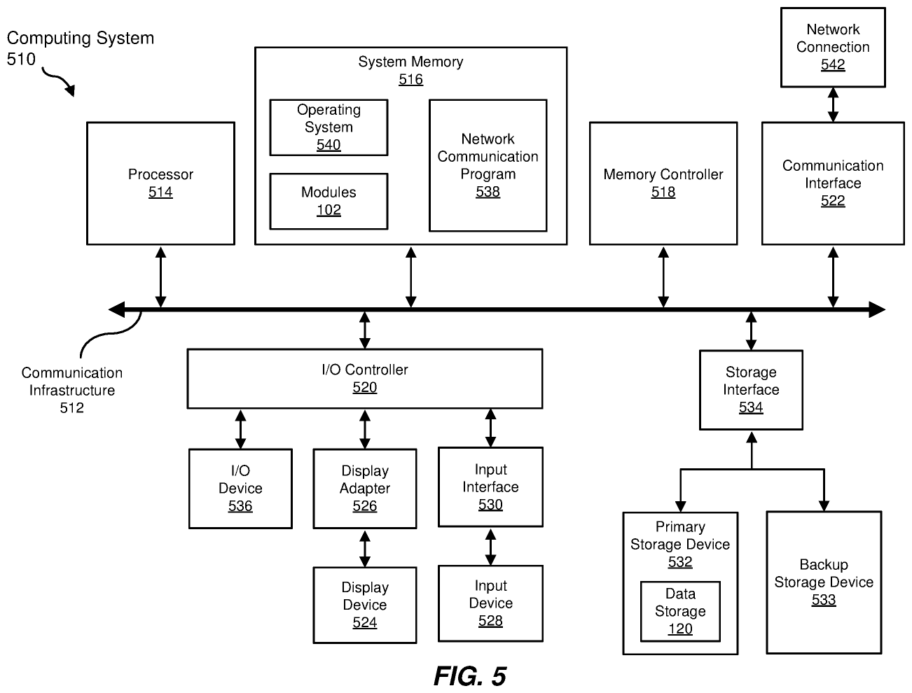

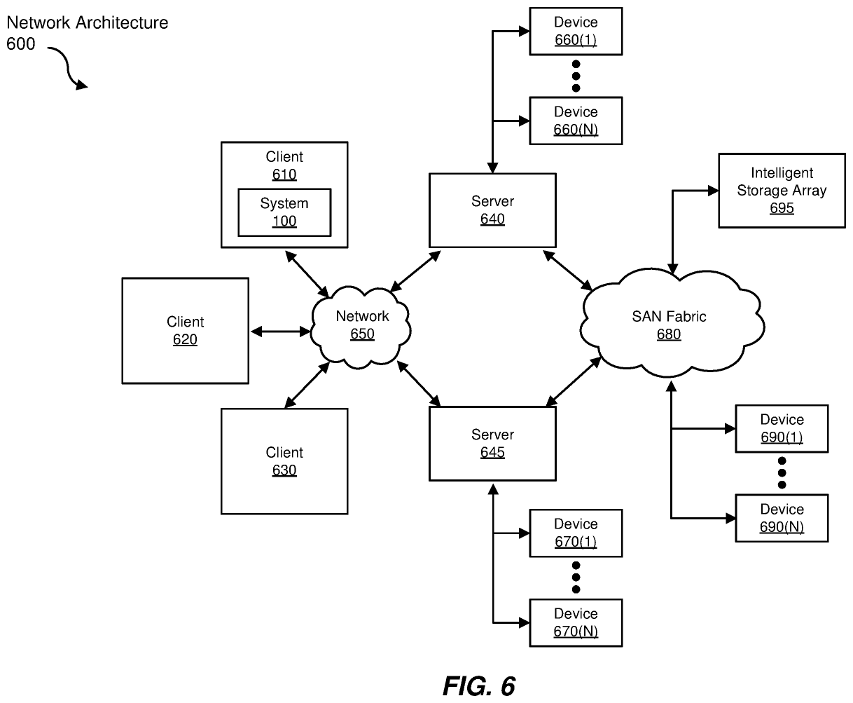

The following will provide, with reference to FIGS. 1, 2, and 4, detailed descriptions of example systems for threat and information protection through file classification. Detailed descriptions of corresponding computer-implemented methods will also be provided in connection with FIG. 3. In addition, detailed descriptions of an example computing system and network architecture capable of implementing one or more of the embodiments described herein will be provided in connection with FIGS. 5 and 6, respectively.

FIG. 1 is a block diagram of an example system 100 for threat and information protection through file classification. As illustrated in this figure, example system 100 may include one or more modules 102 for performing one or more tasks. For example, and as will be explained in greater detail below, example system 100 may include a tagging module 104 that assigns a classification tag 124 to each of one or more files 122 on a computing device based on a set of rules. Example system 100 may additionally include a storage module 106 that stores classification tags 124 in the files 122 and further stores a corresponding file descriptor 126 describing a sensitivity level of the files, based on the rules and externally to the files, on a data storage 120. Example system 100 may also include a detection module 108 that detects creation of a process associated with accessing files 122. Example system 100 may additionally include a determining module 110 that determines whether the process is potentially suspicious. Example system 100 may also include an identification module 112 that identifies, upon determining that the process is potentially suspicious, an operation initiated by the potentially suspicious process to access files 122. Example system 100 may additionally include a security module that performs, based on the sensitivity level of files 122, a security action that protects the computing device from malicious activity by the operation initiated by the potentially suspicious process. Although illustrated as separate elements, one or more of modules 102 in FIG. 1 may represent portions of a single module or application.

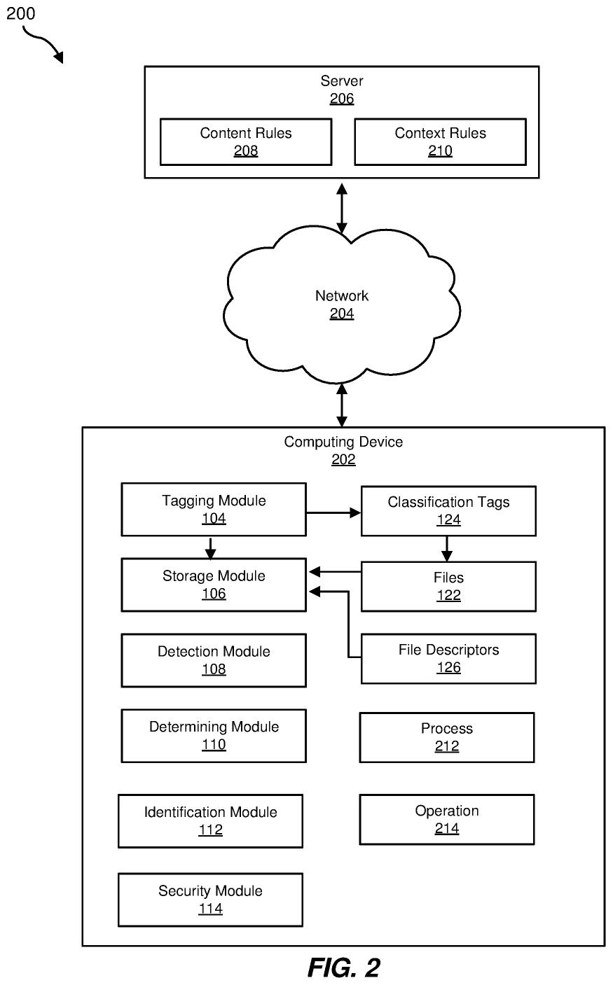

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate threat and information protection through file classification. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202 and/or any other suitable computing system.

As will be described in greater detail below, one or more of modules 102 from FIG. 1 may, when executed by at least one processor of computing device 202, enable computing device 202 to perform threat and information protection through file classification. For example, tagging module 104 may assign a classification tag 124 to each of one or more files 122 based on a set of rules, such as content rules 208 and context rules 210. Next, storage module 106 may store classification tags 124 in files 122 and a corresponding file descriptor 126 describing a sensitivity level of files 122 that is based on content rules 208 and/or context rules 210, externally to files 122. Then, detection module 108 may detect creation of a process 212 associated with accessing files 122. Next, determination module 110 may determine whether any processes 212 are potentially suspicious. Then, identification module 112 may identify, upon determining that a process 212 is potentially suspicious, an operation 214 initiated by the potentially suspicious process to access the files. Finally, security module 114 may perform, based on the sensitivity level of files 122, a security action that protects files 122 from malicious activity by operation 214 initiated by the potentially suspicious process.

Computing device 202 generally represents any type or form of computing device capable of reading computer-executable instructions. In some embodiment, computing device 202 may represent an endpoint computing device. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of storing a set of rules (e.g., content rules 208 and/or context rules 210) that may be utilized to classify files 122 based on the content or context of the information contained therein. For example, content rules 208 and/or context rules 210 may define any files 122 containing confidential company information as highly sensitive (e.g., top secret) while any files 122 containing public information may be defined as having a low (or even no) sensitivity. In one embodiment, server 206 may represent a data loss prevention server. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for threat and information protection through file classification. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may assign a classification tag to each of one or more files on a computing device based on a plurality (e.g., a set) of rules. For example, tagging module 104 may, as part of computing device 202 in FIG. 2, assign a classification tag 124 to each of files 122 based on content rules 208 and/or context rules 210 on server 206.

Tagging module 104 may assign classification tags 124 to files 122 in a variety of ways. For example, tagging module 104 may be part of a data loss prevention policy application that may classify document files when files 122 are created or downloaded to computing device 202, based on content rules 208 and/or context rules 210 on server 206. For example, content rules 208 and/or context rules 210 may describe any files 122 containing confidential or classified company information as having a secret or top secret classification, any files 122 containing non-public company information as having an internal classification, and any files 122 containing public company information as having a public classification. In some examples, content rules 208 may include rules that define file classifications based on the content of information contained in files 122. For example, content rules 208 may include a rule that when the words “confidential” or “eyes only” appear in the header of a file document, or that a file document discusses an upcoming company acquisition, that a file 122 will be classified as secret or top secret. In some examples, context rules 210 may include rules that define file classifications based on the context of information contained in files 122. For example, context rules 210 may include a rule that a file document in a specific location, such as a file system share (e.g., a SHAREPOINT file system share), will also be classified as secret or top secret. In some examples, tagging module 104 may be configured to allow a user to manually assign classification tags 124 to files 122 based on content rules 208 and/or context rules 210. Additionally or alternatively, tagging module 104 may be configured to automatically assign classification tags 124 to files 122 based on content rules 208 and/or context rules 210.

In some examples, classification tags 124 may additionally be associated with a corresponding separate file descriptor 126 that describes a sensitivity level associated with each of files 122. For example, tagging module 104 may also be configured to associate a low sensitivity file descriptor 126 to any files 122 containing public information, a medium sensitivity file descriptor 126 to any files 122 containing internal company information, and a high sensitivity file descriptor 126 to any files 122 containing classified information (e.g., secret or top secret). In some examples, and as will be described in greater detail below, any files 122 classified as having a sensitivity level may represent a threshold for performing various security actions which may be taken upon identifying potentially suspicious processes attempting to access files 122.

At step 304, one or more of the systems described herein may store the classification tag in the files and a file descriptor describing a sensitivity level of the files externally to the files. For example, storage module 106 may, as part of computing device 202 in FIG. 2, store each assigned classification tag 124 within their corresponding files 122. Additionally, storage module 106 may also store each file descriptor 126 describing the sensitivity level of files 122 externally to files 122.

The term “externally to the files,” as used herein, generally refers to any method of data storage where data associated with a file is saved outside of the file contents such that the data may be retrieved independently of accessing the file (e.g., without having to read or open the file itself). In some examples, data associated with a file on a computing device may include a file descriptor that is saved to an external database on the computing device.

Storage module 106 may store classification tags 124 and file descriptors 126 in a variety of ways. In some examples, storage module 106 may save classification tags 124 within their corresponding files 122 on computing device 202 and save file descriptors 126 to an external database accessible by a threat protection application for performing various security actions which may be taken upon identifying potentially suspicious processes attempting to access files 122 (described in greater detail below). Storing file descriptors 126 externally to files 122 allows each file descriptor 126 to be retrieved without reading the actual contents of any files 122. In some examples, storage module 106 may additionally be configured to further update a count corresponding to a number of sensitive files on computing device 202 after storing classification tags 124 and file descriptors 126. In some examples, the aforementioned count information may be used to identify high value endpoints in a computer network. For example, if an endpoint device (e.g., computing device 202) is identified as storing a high number of sensitive files, additional security actions (e.g., threat protection policies) may be applied to prevent actions taken by potentially suspicious processes such as executing aggressive security scan policies and/or locking down the device if the endpoint attempts to connect to a non-secure network.

At step 306, one or more systems described herein may detect the creation of a process associated with accessing the files on the computing device. For example, detection module 108, as part of computing device 202 in FIG. 2, detect the creation of process 212 associated with accessing files 122.

Detection module 108 may detect the creation of process 212 in a variety of ways. For example, detection module 108 may be a component of a threat protection application configured to detect when an instance of an application program is executed on computing device 202 for performing one or more operations 214 with respect to a file 122. For example, process 212 may be executed to perform an open operation, a read operation, a write operation, and/or a delete operation with respect to a file 122.

At step 308, one or more of the systems described herein may determine whether the process detected at step 306 is potentially suspicious. For example, determining module 110 may be a component of a threat protection application configured to determine whether process 212 on computing device 202, is a potentially suspicious process.

The term “potentially suspicious process,” as used herein, generally refers to any process designed to cause changes to a computing device that may impede the computing device's functioning, usability, and/or the security of any files stored thereon. In some examples, a potentially suspicious process may have one or more characteristics or behavior associated with malware as determined by a threat protection application.

Determining module 110 may determine that process 212 is potentially suspicious in a variety of ways. For example, determining module 110 may perform a virus scan of the application program associated with process 212 and determine that process 212 has one or more characteristics or behavior associated with known malware.

At step 310, one or more of the systems described herein may identify, upon determining that the process is potentially suspicious, an operation initiated by the suspicious process to access the files on the computing device. For example, identification module 112 may, as part of computing device 202 in FIG. 2, identify operation 214 initiated by the suspicious process to access files 122.

Identification module 112 may identify operation 214 in a variety of ways. For example, identification module 112 may identify a request by the potentially suspicious operation to open a file 122 on computing device 202. Additionally or alternatively, identification module 112 may identify a request by the potentially suspicious operation to read a file 122. In one example, a request to read a file 122 by a potentially suspicious operation may be to search for sensitive information to be exfiltrated. Additionally or alternatively, identification module 112 may identify a request by the potentially suspicious operation to write to a file 122 on computing device 202. In one example, a request to write to a file 122 by a potentially suspicious operation may be for encrypting, obfuscating, and/or removing sensitive information from computing device 202. Additionally or alternatively, identification module 112 may identify a request by the potentially suspicious operation to delete a file 122 on computing device 202.

At step 312, one or more of the systems described herein may perform, based on the sensitivity level of the files, a security action that protects the files from malicious activity by the operation initiated by the potentially suspicious process. For example, security module 114 may, as part of computing device 202 in FIG. 2, perform a security action based on the sensitivity level of any files 122 that may be accessed by operation 214 identified as being initiated by the potentially suspicious process.

Security module 114 may perform a variety of security actions based on the security level of files 122. For example, security module 114 may initially retrieve a file descriptor 126 describing a sensitivity level of a file 122 from data storage 120. In some examples, if, based on file descriptor 126, the sensitivity level of a file 122 is “low”, then security module 110 may block operation 214 from accessing a file 122 and then sandbox the potentially suspicious process. If, based on file descriptor 126, the sensitivity level of a file 122 is “medium” or “high”, then security module 114 may block operation 214 from accessing a file 122 and then quarantine, terminate, or delete the potentially suspicious process and its associated binaries and content files.

The term “sandbox,” as used herein, generally refers to any security mechanism designed for separating running programs or processes to mitigate malicious activity (e.g., viruses or other malicious code) from spreading on a computing device. In some examples, a sandbox may include a “jail” that imposes network-access restrictions and a restricted filesystem namespace on programs and/or processes.

The term “quarantine,” as used herein, generally refers to any security mechanism designed to isolate files or processes such that they are no longer capable of infecting a host computing device or system as a result of malicious activity. In some examples, a quarantine may allow suspect files or processes to be deleted or moved to a designated “quarantine area” on a computing device.

In some examples, security module 114 may also perform additional security actions that protect files 122, based on a security value associated with computing device 202. For example, if security module 114 determines that computing device 202 is a high value endpoint device (e.g., computing device 202 stores a large number of files 122 having a sensitivity level of “medium” or “high”), then security module 114 may be configured to initiate an aggressive security scan on computing device 202 and/or prevent computing device 202 from connecting to non-secure networks. In some examples, security module 114 may be configured to perform additional security actions for high value endpoint devices even when a process is determined to be safe. For example, if, at step 308, determining module 110 determines that process 212 is not suspicious but computing device 202 is determined to be a high value device, security module 114 may protect the process attempting to access files 122 having a sensitivity level that meet or exceed a sensitivity level threshold.

In some embodiments, security module 114 may perform different security actions for potentially suspicious processes and non-suspicious (e.g., “safe”) processes with respect to files 122 having an assigned sensitivity level. For example, security module 114 may perform a security action such as “jail” sandboxing potentially suspicious processes accessing files 122 having a sensitivity level to restrict network-access and/or filesystem namespace access with respect to files 122. Additionally or alternatively, security module 114 may perform a security action (e.g., a “protect action”) such as “castle” sandboxing non-suspicious processes accessing files 122 having a sensitivity level to protect against memory, code injection, and/or other attacks.

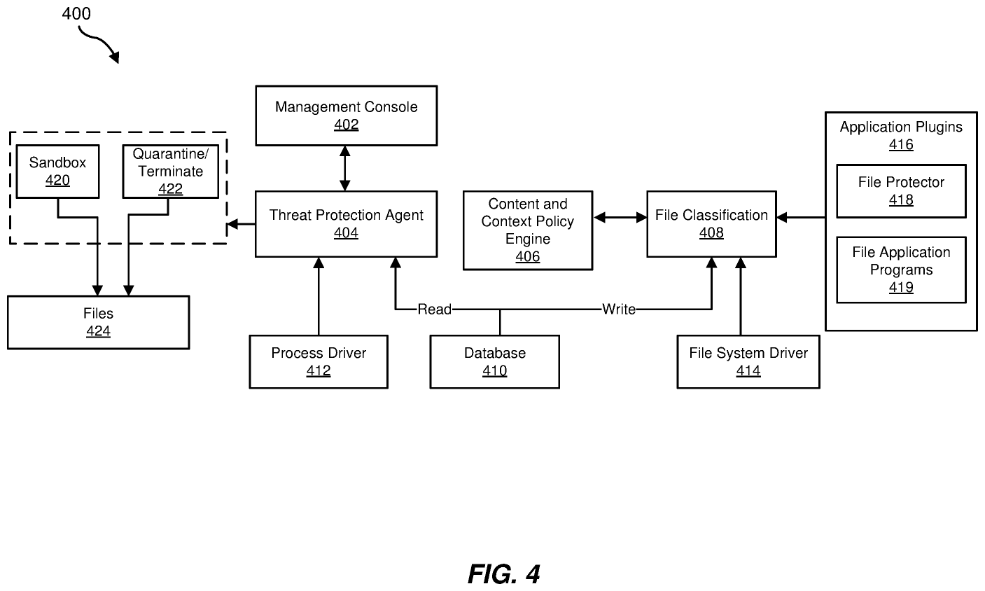

FIG. 4 is a block diagram of an additional example system 400 for threat and information protection through file classification. Example system 400 may include a management console 402, a threat protection agent 404, a content and context policy engine 406, a file classification module 408, a database 410, a process driver 412, a file system driver 414, and application plug-ins 416.

In some embodiments, management console 402 may initiate threat protection agent 404 for threat and information protection through file classification. For example, application plug-ins 416 may include a file protector 418 and file application programs 419 for generating files 424. File protector 418 may comprise a shell extension allowing a user to manually classify the sensitivity of various files 424 (i.e., a user may manually tag files 424). For example, files 424 may be classified as public, internal, secret, or top secret. In some examples, files 424 may be classified as they are being created using file application programs 419. In some examples, files 424 may be automatically classified (or tagged) based on rules in content and context policy engine 406 via file classification module 408. Then, utilizing file system driver 414, file classification module 408 may write the classifications assigned to files 424 when they are downloaded or copied on the system.

Threat protection agent 404 may read the file classifications from database 410 and, utilizing process driver 412, determine any potentially suspicious processes attempting to access any files 424. Upon determining a potentially suspicious process attempting to access a file 424, threat protection agent 404 may then initiate remediation actions such as blocking the potentially suspicious process from executing and further sandboxing 420 or quarantining/terminating 422 the potentially suspicious processes so that they will be prevented from attempting to access any additional files 424 for potentially malicious purposes.

As described in connection with method 300 above, the systems and methods described herein may use file classification tagging to protect computing devices from operations initiated by potential suspicious processes, such as the exfiltration of sensitive information. The systems described herein may include a classification agent that tags files based on content and context rules. The classification tags may be stored in the files. Based on the tag, an additional descriptor describing the sensitive level of the files may be stored external to the file such that may be retrieved without reading the actual file contents or the tag. Whenever a process is created on the computing device, the systems described herein may include a threat protection agent that identifies the type of process. If the process is potentially suspicious, the threat protection agent may additionally monitor the type of files it accesses. If the process accesses a file having a security level, the threat protection agent may block an operation (e.g., open, read, write, or delete) associated with the file and take appropriate actions including, without limitation, sandboxing the process, terminating the process, and/or quarantining the process or, alternatively, the computing device (e.g., an endpoint) from a network and additionally executing an aggressive security scan.

The action taken by the threat protection agent may depend upon the sensitivity level of the file. For example, if a file has a “low” sensitively level, the potentially suspicious process may be sandboxed but, if the file has a “medium” or “high” sensitivity level, the process may be terminated and quarantined or deleted. If a process is determined to be safe but accesses a sensitive file, the systems described herein may cause the threat protection agent to dynamically protect the process against memory, code injection and/or other attacks that could compromise an application accessing the file. When a sensitivity level of a file is stored, the classification agent may update a total count of sensitive files on a computing device or system. The count information may then be used for determining high valued endpoints where additional threat protection policies may be applied to prevent data loss (e.g., if a high valued endpoint device attempts to connect to a non-secure network, the device may be locked down).

FIG. 5 is a block diagram of an example computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 3). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the example embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below). In one example, one or more of modules 102 from FIG. 1 may be loaded into system memory 516.

In some examples, system memory 516 may store and/or load an operating system 540 for execution by processor 514. In one example, operating system 540 may include and/or represent software that manages computer hardware and software resources and/or provides common services to computer programs and/or applications on computing system 510. Examples of operating system 540 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

As illustrated in FIG. 5, computing system 510 may also include at least one display device 524 coupled to I/O controller 520 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, example computing system 510 may also include at least one input device 528 coupled to I/O controller 520 via an input interface 530. Input device 528 generally represents any type or form of input device capable of providing input, either computer or human generated, to example computing system 510. Examples of input device 528 include, without limitation, a keyboard, a pointing device, a speech recognition device, variations or combinations of one or more of the same, and/or any other input device.

Additionally or alternatively, example computing system 510 may include additional I/O devices. For example, example computing system 510 may include I/O device 536. In this example, I/O device 536 may include and/or represent a user interface that facilitates human interaction with computing system 510. Examples of I/O device 536 include, without limitation, a computer mouse, a keyboard, a monitor, a printer, a modem, a camera, a scanner, a microphone, a touchscreen device, variations or combinations of one or more of the same, and/or any other I/O device.

Communication interface 522 broadly represents any type or form of communication device or adapter capable of facilitating communication between example computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

In some examples, system memory 516 may store and/or load a network communication program 538 for execution by processor 514. In one example, network communication program 538 may include and/or represent software that enables computing system 510 to establish a network connection 542 with another computing system (not illustrated in FIG. 5) and/or communicate with the other computing system by way of communication interface 522. In this example, network communication program 538 may direct the flow of outgoing traffic that is sent to the other computing system via network connection 542. Additionally or alternatively, network communication program 538 may direct the processing of incoming traffic that is received from the other computing system via network connection 542 in connection with processor 514.

Although not illustrated in this way in FIG. 5, network communication program 538 may alternatively be stored and/or loaded in communication interface 522. For example, network communication program 538 may include and/or represent at least a portion of software and/or firmware that is executed by a processor and/or Application Specific Integrated Circuit (ASIC) incorporated in communication interface 522.

As illustrated in FIG. 5, example computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510. In one example, data storage 120 from FIG. 1 may be stored and/or loaded in primary storage device 532.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 510 may be configured as an Application Specific Integrated Circuit (ASIC) adapted to implement one or more of the example embodiments disclosed herein.

FIG. 6 is a block diagram of an example network architecture 600 in which client systems 610, 620, and 630 and servers 640 and 645 may be coupled to a network 650. As detailed above, all or a portion of network architecture 600 may perform and/or be a means for performing, either alone or in combination with other elements, one or more of the steps disclosed herein (such as one or more of the steps illustrated in FIG. 3). All or a portion of network architecture 600 may also be used to perform and/or be a means for performing other steps and features set forth in the instant disclosure.

Client systems 610, 620, and 630 generally represent any type or form of computing device or system, such as example computing system 510 in FIG. 5. Similarly, servers 640 and 645 generally represent computing devices or systems, such as application servers or database servers, configured to provide various database services and/or run certain software applications. Network 650 generally represents any telecommunication or computer network including, for example, an intranet, a WAN, a LAN, a PAN, or the Internet. In one example, client systems 610, 620, and/or 630 and/or servers 640 and/or 645 may include all or a portion of system 100 from FIG. 1.

As illustrated in FIG. 6, one or more storage devices 660(1)-(N) may be directly attached to server 640. Similarly, one or more storage devices 670(1)-(N) may be directly attached to server 645. Storage devices 660(1)-(N) and storage devices 670(1)-(N) generally represent any type or form of storage device or medium capable of storing data and/or other computer-readable instructions. In certain embodiments, storage devices 660(1)-(N) and storage devices 670(1)-(N) may represent Network-Attached Storage (NAS) devices configured to communicate with servers 640 and 645 using various protocols, such as Network File System (NFS), Server Message Block (SMB), or Common Internet File System (CIFS).

Servers 640 and 645 may also be connected to a Storage Area Network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 645, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to example computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the example embodiments disclosed herein may also be encoded as a computer program, stored in server 640, run by server 645, and distributed to client systems 610, 620, and 630 over network 650.

As detailed above, computing system 510 and/or one or more components of network architecture 600 may perform and/or be a means for performing, either alone or in combination with other elements, one or more steps of an example method for threat and information protection through file classification.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for threat and information protection through file classification, at least a portion of the method being performed by a computing device comprising at least one processor, the method comprising:
assigning a classification tag to each of one or more files on the computing device based on a plurality of rules;
storing, by the computing device, the classification tag in the files and a corresponding file descriptor describing a sensitivity level of the files, based on the rules, externally to the files;
detecting, by the computing device, creation of a process associated with accessing the files;
determining, by the computing device, whether the process is potentially suspicious;
identifying, by the computing device, upon determining that the process is potentially suspicious, an operation initiated by the potentially suspicious process to access the files; and
performing, by the computing device, based on the sensitivity level of the files, a security action that protects the computing device from malicious activity by the operation initiated by the potentially suspicious process.

2. The computer-implemented method of claim 1, wherein performing the security action comprises retrieving the file descriptor stored externally to the files from a data storage, wherein the file descriptor is retrieved without reading content contained in the files.

3. The computer-implemented method of claim 1, wherein performing the security action comprises:
blocking the operation; and
sandboxing the potentially suspicious process when the sensitivity level of the files is below a sensitivity threshold.

4. The computer-implemented method of claim 1, wherein performing the security action comprises:
blocking the operation; and
terminating the potentially suspicious process when the sensitivity of the files meets or exceeds a sensitivity threshold.

5. The computer-implemented method of claim 1, wherein performing the security action comprises:
blocking the operation; and
quarantining the potentially suspicious process when the sensitivity of the files meets or exceeds a sensitivity threshold.

6. The computer-implemented method of claim 1, wherein performing the security action comprises:
blocking the operation; and
deleting the potentially suspicious process and associated binary and content files when the sensitivity of the files meets or exceeds a sensitivity threshold.

7. The computer-implemented method of claim 1, further comprising performing, based on a security value associated with the computing device, an additional security action comprising:
initiating a security scan on the computing device; and
preventing the computing device from connecting to a non-secure network.

8. The computer-implemented method of claim 1, wherein determining whether the process is potentially suspicious comprises determining that the process is not suspicious.

9. The computer-implemented method of claim 8, further comprising performing an additional security action to protect the process, upon determining that the process is not suspicious, when the sensitivity level of the files meets or exceeds a sensitivity threshold.

10. The computer-implemented method of claim 1, wherein storing the classification tag and the corresponding file descriptor comprises updating a count corresponding to a number of sensitive files on the computing device.

11. The computer-implemented method of claim 1, wherein the rules comprise at least one of content rules and context rules.

12. A system for threat and information protection through file classification, the system comprising:
at least one physical processor;
physical memory comprising a plurality of modules and computer-executable instructions that, when executed by the physical processor, cause the physical processor to:
assign, by a tagging module, a classification tag to each of one or more files on a computing device based on a plurality of rules;
store, by a storage module, the classification tag in the files and a corresponding file descriptor describing a sensitivity level of the files, based on the rules, externally to the files;
detect, by a detection module, creation of a process associated with accessing the files;
determine, by a determining module, whether the process is potentially suspicious;
identify, by an identification module, upon determining that the process is potentially suspicious, an operation initiated by the potentially suspicious process to access the files; and
perform, by a security module, based on the sensitivity level of the files, a security action that protects the computing device from malicious activity by the operation initiated by the potentially suspicious process.

13. The system of claim 12, wherein the security module performs the security action by retrieving the file descriptor stored externally to the files from a data storage, wherein the file descriptor is retrieved without reading content contained in the files.

14. The system of claim 12, wherein the security module performs the security action by:
blocking the operation; and
sandboxing the potentially suspicious process when the sensitivity level of the files is below a sensitivity threshold.

15. The system of claim 12, wherein the security module performs the security action by:
blocking the operation; and
terminating the potentially suspicious process when the sensitivity of the files meets or exceeds a sensitivity threshold.

16. The system of claim 12, wherein the security module performs the security action by:
blocking the operation; and
quarantining the potentially suspicious process when the sensitivity of the files meets or exceeds a sensitivity threshold.

17. The system of claim 12, wherein the security module performs the security action by:
blocking the operation; and
deleting the potentially suspicious process and associated binaries and content files when the sensitivity of the files meets or exceeds a sensitivity threshold.

18. The system of claim 12, wherein the security module performs, based on a security value associated with the computing device, an additional security action comprising:
initiating a security scan on the computing device; and
preventing the computing device from connecting to a non-secure network.

19. The system of claim 12, wherein the determining module determines whether the process is potentially suspicious comprises by determining that the process is not suspicious.

20. A non-transitory computer-readable medium comprising one or more computer-executable instructions that, when executed by at least one processor of a computing device, cause the computing device to:
assign a classification tag to each of one or more files on the computing device based on a plurality of rules;
store the classification tag in the files and a corresponding file descriptor describing a sensitivity level of the files, based on the rules, externally to the files;
detect creation of a process associated with accessing the files;
determine whether the process is potentially suspicious;
identify, upon determining that the process is potentially suspicious, an operation initiated by the potentially suspicious process to access the files; and
perform, based on the sensitivity level of the files, a security action that protects the computing device from malicious activity by the operation initiated by the potentially suspicious process.
